(19) United States
(12) Patent Application Publication
(10) Pub. No.: US 2008/0246274 A1
(43) Pub. Date: Oct. 9, 2008

(54) Coupling

(75) Inventors: Axel Feger, Lorrach (DE); Michael Trede, Habsheim (FR)

Correspondence Address: BAKER & DANIELS LLP;111 E. WAYNE STREET, SUITE 800, FORT WAYNE, IN, 46802, US

(73) Assignee: A. RAYMOND ET CIE, Grenoble (FR)

(21) Appl. No.: 12/092,331

(22) PCT Filed: Oct. 19, 2006
(86) PCT No.: PCT/EP06/10074

§ 371 Date: May 1, 2008

(30) Foreign Application Priority Data
Dec. 16, 2005 (DE) 10 2005 060 135.9

(51) Int. Cl. F16L 37/098

(52) U.S. Cl. 285/80

(57) ABSTRACT

The invention relates to a coupling comprising a receiving part (2) and a fixing part (1) which can be introduced into the receiving part (2), which comprises at least one rear snap-on piece (6) enabling an insertion part (15) to be connected to the receiving part (2) by rear catching a retaining ring (17). The fixing part (1) comprises an annular sleeve (4), wherein each rear snap-on piece (6) and at least one blocking piece (8) are attached by means of a flexible strip (5, 7). After inserting the insertion part (15), each blocking piece (8) is blocked in a radial manner in the inward direction by the insertion part (15) in the movement of the spring by the insertion part (15), such that it is opposite the stop wall (29) of an abutment wall (30). Each rear snap-on piece (6) is covered by a cover wall (27) such that access from the outside to each blocking piece (8) is prevented. As a result, the insertion part (15) can be connected to the receiving part (2) in a safe and non-detachable manner and with relatively little effort, in said simple construction.

### CROSS-REFERENCE TO RELATED APPLICATION

This application is a U.S. National Phase Patent Application based on International Application Serial No. PCT/EP2006/010074 filed Oct. 19, 2006, the disclosure of which is hereby explicitly incorporated by reference herein.

### BACKGROUND OF THE INVENTION

1. Field of the Invention

The present invention relates to a coupling.

2. Description of the Related Art

One known coupling is disclosed in EP 1 380 791 A1. This coupling for the detachable connection of two line ends of a fluid line system has a receiving part and a fixing part that can be inserted in the receiving part. The fixing part is formed with a circumferentially closed annular sleeve to which integrally molded rear snap-on pieces are attached by means of flexible strips. The rear snap-on pieces are located with chamfer surfaces formed on their ends facing away from the annular sleeve partly under a radially inward projecting front collar formed on the receiving part, in order to secure the fixing part against unintentionally slipping out of the receiving part before the introduction of an insertion part. The rear snap-on pieces serve for the rear engagement of a retaining ring formed on an insertion part to be introduced in the coupling, some rear snap-on pieces being formed with linking levers protruding from the recesses, which can be moved inward radially and interact with projections formed on the receiving part, in order to move the fixing part together with the insertion part outward axially from the cover by means of the front collar such that the rear snap-on pieces lie exposed and can be moved radially to disengage the rear engagement with the retaining ring of an insertion part inserted in the coupling.

A coupling for the non-detachable connection of two line ends of a fluid line system is known from EP 0 459 016 A1, which has, primarily for assembly purposes, a receiving part designed in two parts with a screw connection to receive an insertion part formed with a retaining ring and a fixing part that can be inserted in the receiving part. The fixing part is formed with at least one rear snap-on piece with which an insertion part can be connected by rear catching the retaining ring with the receiving part. Furthermore, the fixing part has a circumferentially closed annular sleeve, the or each rear snap-on piece being attached on one side of the annular sleeve by means of one flexible strip flexing in the radial direction and one extending axially and the or each rear snap-on piece being covered by a completely closed radially external cover wall of the receiving part, so that the or each rear snap-on piece is completely shielded against access from without. With their ends facing away from the annular sleeve, the rear snap-on pieces abut a radially inward projecting ring collar formed on the receiving part, in order to secure the fixing part against unintentionally slipping out of the receiving part before the introduction of an insertion part. Because of the complete shielding of the fixing part, however, no control is possible with regard to a proper arrangement of the fixing part in the receiving part, for example.

From DE 44 13 345 C1, a coupling is known for the connection of two line ends of a fluid line system, which has a receiving part and a fixing part that can be inserted in the receiving part. The fixing part is formed with a circumferentially closed annular sleeve to which integrally molded rear snap-on pieces are attached by means of flexible strips. The rear snap-on pieces abut chamfer surfaces formed on a closing collar with their ends facing away from the annular sleeve formed on the receiving part, in order to secure the fixing part against unintentionally slipping out of the receiving part before the introduction of an insertion part. The rear snap-on pieces are for the rear engagement of a retaining ring comprising an insertion part to be introduced in the coupling, the rear snap-on pieces being arranged in the recesses formed in the receiving part. An intentional detachment of the fluid line connection is possible by means of a radial inside chamfer surface on each rear snap-on piece.

From DE 195 40 784 A1, a coupling for the connection of two line ends of a fluid line system is known which has a receiving part for receiving an insertion part formed with a retaining ring. Furthermore, it has an annular fixing part which can be inserted in the receiving part and which has two rear snap-on pieces enabling an insertion part to be connected to the receiving part by rear catching a retaining ring. In this known coupling, the rear snap-on pieces are each connected by means of two flexible strips attached on the side to pressure plates which are located between the rear snap-on pieces and which are arranged in assigned apertures of the receiving part. By the exertion of opposing pressure forces directed radially inward on the pressure plates, the rear snap-on pieces move radially outward and thus release an insertion part inserted in the receiving part, a not inconsiderable amount of force being required, due to the fastening by means of the flexible strips attached on the sides, to achieve the proper rear catching of the retaining ring.

### SUMMARY OF THE INVENTION

The present invention provides a coupling, with which an insertion part can be connected to a receiving part in a secure and non-detachable manner, using relatively little force and in the simplest possible construction.

In the coupling according to the invention, access to the rear snap-on piece arranged in the protective space to move the rear snap-on piece outward radially is prevented, except with completely incorrect, forcible action, by means of the cover wall completely encircling the relevant protective space. The fixing part itself is secured by the interaction of the stop wall of the or each blocking piece with an abutment wall formed on the receiving part and, because of the arrangement of the or each blocking piece, can be controlled in a window aperture with respect to a proper arrangement and non-detachably connected with the receiving part after introduction of the insertion part. Further useful embodiments of the invention are the subject of the subclaims.

In one form thereof, the present invention provides a coupling to connect two line ends of a fluid line system having a receiving part to receive an insertion part formed with a retaining ring and having a fixing part which can be introduced into the receiving part, which includes at least one rear snap-on piece enabling an insertion part to be connected to the receiving part by rear catching a retaining ring, the fixing part including a circumferentially closed annular sleeve, the or each rear snap-on piece being attached on one side of the annular sleeve by means of one flexible strip flexing in the radial direction and one extending axially and the or each rear snap-on piece lying opposite a front collar formed on the receiving part, characterized in that at least one blocking piece is present, which is attached by means of a flexible strip on the annular sleeve and which has a radially oriented stop wall, that in a head segment of the receiving part there is at least one window aperture assigned to each blocking piece which is dimensioned such that the relevant blocking piece can be positioned within it and which has a radially oriented abutment wall, that the or each blocking piece is arranged in the relevant window aperture such that the stop wall and the abutment wall are located opposite one another, that a head segment of the receiving part for each rear snap-on piece is formed with a protective space fully enclosed by a cover wall assigned to the respective rear snap-on piece, the protective space completely shielding the relevant rear snap-on piece against access from without and being dimensioned such that the relevant rear snap-on piece can be deflected radially outward without obstruction when the insertion part is introduced, that the or each blocking piece after insertion of the insertion part is blocked by the insertion part in the inward radial flexing movement, so that the insertion part is connected with the receiving part in a non-detachable manner except for incorrect, forcible action.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a perspective exploded view of an exemplary embodiment of a coupling according to the invention, consisting of a receiving part, a fixing part and a single sealing ring, together with an insertion part which can be inserted in the receiving part; and

FIG. 2 is an exemplary embodiment according to FIG. 1 with an insertion part inserted in the coupling according to the invention.

Corresponding reference characters indicate corresponding parts throughout the several views. Although the exemplification set out herein illustrates an embodiment of the invention, the embodiment disclosed below is not intended to be exhaustive or to be construed as limiting the scope of the invention to the precise form disclosed.

### DETAILED DESCRIPTION

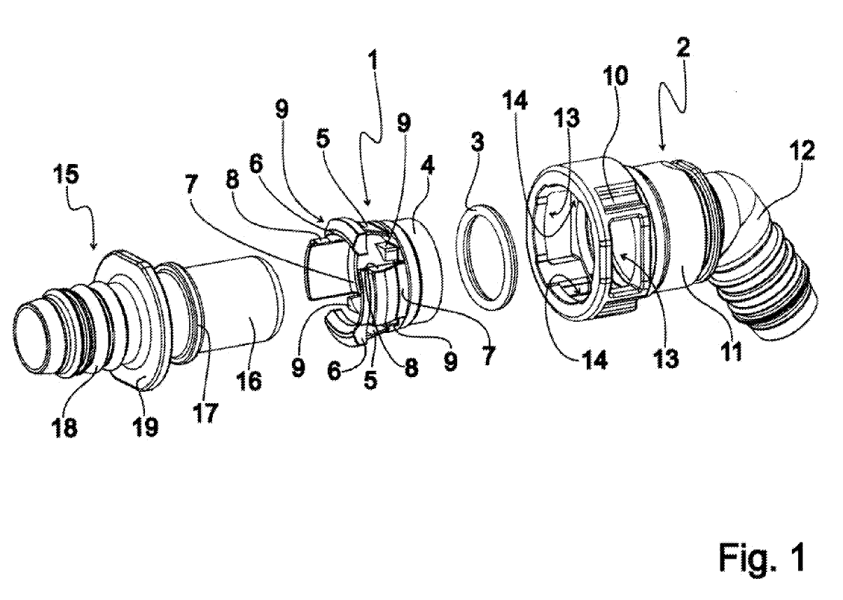

FIG. 1 shows, in a perspective exploded view, an exemplary embodiment of a coupling according to the invention, consisting of a fixing part 1, a receiving part 2 and a single ring seal in the form of an o-ring. The insertion part 1 has an annular sleeve 4, which is made essentially cylindrical in shape, on which two rear snap-on pieces 6 lying diametrically opposite one another are connected by means of a first flexible strip 5 attached on a front side and extending in the axial direction. Furthermore, a second set of flexible strips 7 are arranged between the first two flexible strips 5 on the same front side of the annular sleeve 4, on which blocking pieces 8 are integrally formed, likewise diametrically opposite one another. Between the first flexible strips 5 and the second flexible strips 7, stop projections 9 protruding beyond the front side of the annular sleeve 4 are formed.

The receiving part 2 of the exemplary embodiment shown of a coupling according to the invention has a head segment 10, a center segment 11 and a connecting piece 12 arranged on the side of the center segment 11 located opposite the head segment 10, which can be connected in the known manner with a line end of a fluid line system. The head segment 10 is formed with window apertures 13 located diametrically opposite one another, which are dimensioned such that the blocking pieces 8 can be positioned inside them. Furthermore, it can be seen from FIG. 1 that the head segment 10 is formed with two protective spaces 14 located opposite one another, which are dimensioned such that the rear snap-on pieces 6 can be positioned radially outward inside them with a certain movability.

FIG. 1 further depicts an insertion part 15, which has an end segment 16 that is essentially cylindrical in shape and smooth-walled on the outside to connect with the coupling according to the invention. The insertion part 15 is formed with an encircling retaining ring 17 that protrudes outward in the radial direction beyond the end segment 16 and has a connecting piece 18 on the side of the retaining ring 17 located opposite the end segment 16 which can be connected with another line end of the fluid line system. Between the retaining ring 17 and the connecting piece 18, an encircling front collar 19 is formed, which, like the retaining ring 17, protrudes radially outward beyond the end segment, but is dimensioned larger in circumference than the retaining ring 17.

In other embodiments not shown, the front collar 19 is integrated in a wall of a component formed as a single piece with the insertion part 15 on which the coupling according to the invention can be can be fixed.

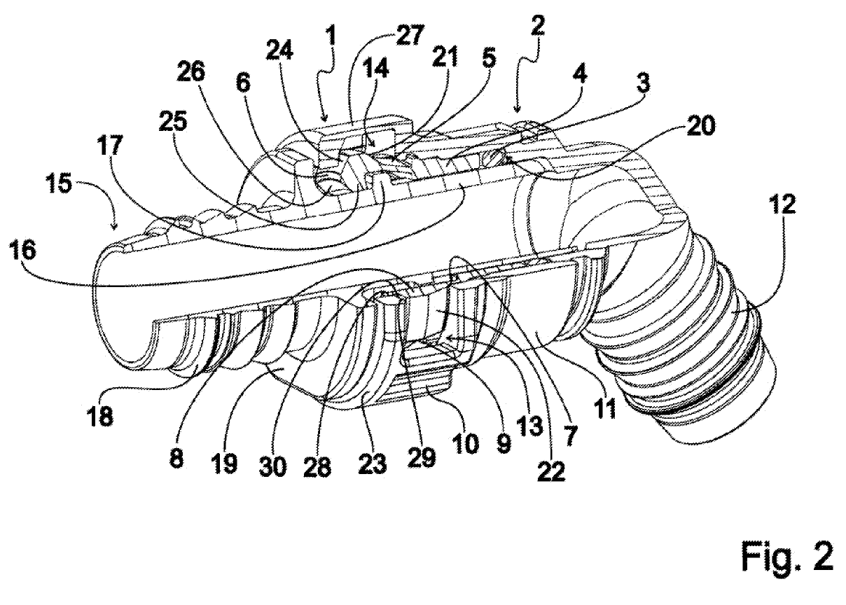

FIG. 2 shows the exemplary embodiment according to FIG. 1 with the coupling according to the invention in an assembled arrangement in which the fixing part 1 and the ring seal 3 are inserted in the receiving part 2, the retaining ring 17 of the insertion part 15 abutting the stop projections 9 that serve to protect the flexible strips 5, 7 without acting on the flexible strips 5, 7. In this arrangement, the ring seal 3 is arranged in a ring groove 20 and lies near to the front side of the annular sleeve 4 located opposite the flexible strips 5, 7. It can be seen from FIG. 2 that the annular sleeve 4 has a stepped structure radially on the outside with wall thickness increasing in the direction of the flexible strips 5, 7, which sits in contact with a complementarily shaped, radially inward-facing inside wall of the center segment 11 of the receiving part 2. The result is a limit stop and a boundary of a receiving space that receives the ring seal 3 on the side opposite the ring groove 20.

The rear snap-on pieces 6 and the blocking pieces 8 are formed with lead-in chamfers 21, 22 facing the annular sleeve 4, to facilitate the insertion of the fixing part 1 by the sliding of the lead-in chamfers 21, 22 on the front side of a front collar 23 terminating the head segment 10 with deflection of the flexible strips 5, 7 radially inward. The rear snap-on pieces 6 are further formed with pressing chamfers 24, arranged opposite the lead-in chamfers 21, which face a closing-side front collar 23 of the receiving part 2 and have catch projections 25 that protrude radially inward and, as shown in FIG. 2, serve for the rear engagement of the retaining ring 17 of an insertion part 15. To simplify the introduction of an insertion part 15, the catch projections 25 have beveled sliding chamfers 26, which bring about a relatively low-force outward radial deflection of the rear snap-on pieces 6 during the introduction of the insertion part 15 on passing over by the retaining ring 17, for which the protective spaces 14 are dimensioned such that there are no obstacles.

In order to completely shield the rear snap-on pieces 6 against access from without, the protective spaces 14 preferably exhibit a cover wall 27 that is completely closed to the outside.

In FIG. 2, the blocking pieces 8 shown inside the window apertures 13 have, arranged opposite the second flexible strips 7, axially protruding closing strips 28, which abut the radially inward-facing inside wall of the front collar 23. The blocking pieces 8 are furthermore each formed with a radially oriented stop wall 29, lying opposite a likewise radially oriented abutment wall 30 of the front collar 23, forming the boundary of the window apertures 13.

In the exemplary embodiment shown, the blocking pieces 8 are obstructed in their radial inward motion by the retaining ring 17 in a timely manner such that at least segments of the stop walls 29 remain facing opposite the abutment wall 30. In this way, if there is movement of an insertion part 15 inserted in the coupling according to the invention against the insertion direction out of the receiving part 2, the fixing part 1 is secured against removal from the receiving part 2 by the stop wall 29 hitting the abutment wall 30, with the catch projections 25 being pressed in the direction of the end segment 16 of the insertion part 15 due to the contact of the pressing chamfers 24 with the front collar 23 and thus preventing the retaining ring 17 from sliding on the catch projections 25.

Thus, with a relatively simply constructed embodiment of the coupling according to the invention, made of only three parts, the insertion part 15 is latched in a non-detachable manner.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-5. (canceled)

6. A coupling for use in connecting two line ends of a fluid line system, said coupling comprising:
a receiving part;
an insertion part insertable into said receiving part and including a retaining ring; and
a fixing part receivable within said receiving part;
said fixing part including at least one rear snap-on piece engaging said retaining ring of said insertion part upon insertion of said insertion part into said receiving part, said fixing part further including a circumferentially closed annular sleeve, each said rear snap-on piece connected on one side thereof to said annular sleeve by an axially extending flexible strip that is flexible in a radial direction, and each said rear snap-on piece disposed opposite a front collar formed on said receiving part, said fixing part further including at least one blocking piece having a radially oriented stop wall and connected to said annular sleeve by a flexible strip;
said receiving part further including a head segment including a window aperture aligned with each said blocking piece and dimensioned such that each said blocking piece is positionable within said window aperture, each window aperture including a radially oriented abutment wall, and each blocking piece receivable within a window aperture such that said stop wall and said abutment wall are located opposite one another; and
said head segment of said receiving part including a protective space for each said rear snap-on piece, each said protective space enclosed by a cover wall, said protective space shielding said rear snap-on piece from access externally of said receiving part and dimensioned to allow deflection of said rear snap-on piece radially outwardly without obstruction upon insertion of said insertion part into said receiving part, with each said blocking piece blocked by said insertion part from radially inward flexing movement, whereby said insertion part is connected within said receiving part in a non-detachable manner.

7. The coupling of claim 6, further comprising a closing strip integrally formed on each said blocking piece, each said closing strip extending in the axial direction beyond said abutment wall and abutting a radially inwardly-facing wall of a front collar of said receiving part.

8. The coupling of claim 6, wherein said annular sleeve of said fixing part includes a radially stepped structure on an external surface thereof, said stepped structure having a wall thickness increasing in a direction of said flexible strips.

9. The coupling of claim 6, wherein each said blocking piece and each said rear snap-on piece includes at least one lead-in chamfer facing in a direction of said annular sleeve.

10. The coupling of claim 6, wherein each said rear snap-on piece includes a pressing chamfer set radially outwardly and facing in a direction away from said annular sleeve, and a sliding chamfer facing radially inwardly.
